(19) United States
(12) Patent Application Publication
(10) Pub. No.: US 2008/0148241 A1
(43) Pub. Date: Jun. 19, 2008

(54) METHOD AND APPARATUS FOR PROFILING HEAP OBJECTS

(76) Inventors: SCOTT THOMAS JONES, Austin, TX (US); Frank Eliot Levine, Austin, TX (US); Milena Milenkovic, Austin, TX (US); Enio Manuel Pineda, Austin, TX (US)

Correspondence Address: IBM CORP (YA);C/O YEE & ASSOCIATES PC, P.O. BOX 802333, DALLAS, TX, 75380, US

(21) Appl. No.: 11/548,564

(22) Filed: Oct. 11, 2006

(51) Int. Cl. G06F 9/44

(52) U.S. Cl. 717/130

(57) ABSTRACT

A computer implemented method, apparatus, and computer usable program code for profiling objects. A set of data addresses for a set of objects is identified in response to detecting an event involving a set of objects. A determination is made as to whether any of the set of objects are located in a heap for a virtual machine using the set of data addresses. Call stack information for a thread causing the event is obtained in response to an object in the set of objects being located in the heap, wherein the call stack information is obtained for each object in the set of objects present in the heap.

### BACKGROUND OF THE INVENTION

1. Field of the Invention

The present invention relates generally to an improved data processing system and in particular to a method and apparatus for processing data. Still more particularly, the present invention relates to a computer implemented method, apparatus, and computer usable program code for profiling data objects.

2. Description of the Related Art

In writing code, runtime analysis of the code is often performed as part of an optimization process. Runtime analysis is used to understand the behavior of components or modules within the code using data collected during the execution of the code. The analysis of the data collected may provide insight to various potential misbehaviors in the code. For example, an understanding of execution paths, code coverage, memory utilization, memory errors and memory leaks in native applications, performance bottlenecks, and threading problems are examples of aspects that may be identified through analyzing the code during execution.

The performance characteristics of code may be identified using a software performance analysis tool. The identification of the different characteristics may be based on a trace facility of a trace system. A trace tool may be used to provide information, such as execution flows as well as other aspects of an executing program. A trace may contain data about the execution of code. For example, a trace may contain trace records about events generated during the execution of the code. A trace also may include information, such as, a process identifier, a thread identifier, and a program counter. Information in the trace may vary depending on the particular profile or analysis that is to be performed. A record is a unit of information relating to an event that is detected during the execution of the code.

Currently available performance analysis tools focus on the execution flow and events that occur during the execution of the code.

### SUMMARY OF THE INVENTION

The illustrative embodiments provide a computer implemented method, apparatus, and computer usable program code for profiling objects. A set of data addresses for a set of objects is identified in response to detecting an event involving a set of objects. A determination is made as to whether any of the set of objects are located in a heap for a virtual machine using the set of data addresses. Call stack information for a thread causing the event is obtained in response to an object in the set of objects being located in the heap, wherein the call stack information is obtained for each object in the set of objects present in the heap.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a data processing system in which illustrative embodiments may be implemented;

FIG. 2 depicts a block diagram of a data processing system in which illustrative embodiments may be implemented;

FIG. 3 is a diagram illustrating components used in profiling heap objects in accordance with an illustrative embodiment;

FIG. 4 is a diagram illustrating components used in determining whether objects are present in a heap and to obtain call stack information in accordance with an illustrative embodiment;

FIG. 5 is a diagram illustrating state information in accordance with an illustrative embodiment;

FIG. 6 is a diagram of a call tree in accordance with an illustrative embodiment;

FIG. 7 is a diagram illustrating information in a node in accordance with an illustrative embodiment;

FIG. 8 is a flowchart of a process for signaling a cache miss in a profiler in accordance with an illustrative embodiment; and

FIG. 9 is a flowchart of a process for identifying and profiling a heap object in accordance with an illustrative embodiment.

### DETAILED DESCRIPTION OF THE PREFERRED EMBODIMENT

With reference now to the figures and in particular with reference to FIG. 1, a pictorial representation of a data processing system is shown in which illustrative embodiments may be implemented. Computer 100 includes system unit 102, video display terminal 104, keyboard 106, storage devices 108, which may include floppy drives and other types of permanent and removable storage media, and mouse 110. Additional input devices may be included with personal computer 100. Examples of additional input devices include a joystick, touchpad, touch screen, trackball, microphone, and the like.

Computer 100 may be any suitable computer, such as an IBM® eServer™ computer or IntelliStation® computer, which are products of International Business Machines Corporation, located in Armonk, N.Y. Although the depicted representation shows a personal computer, other embodiments may be implemented in other types of data processing systems. For example, other embodiments may be implemented in a network computer. Computer 100 also preferably includes a graphical user interface (GUI) that may be implemented by means of systems software residing in computer readable media in operation within computer 100.

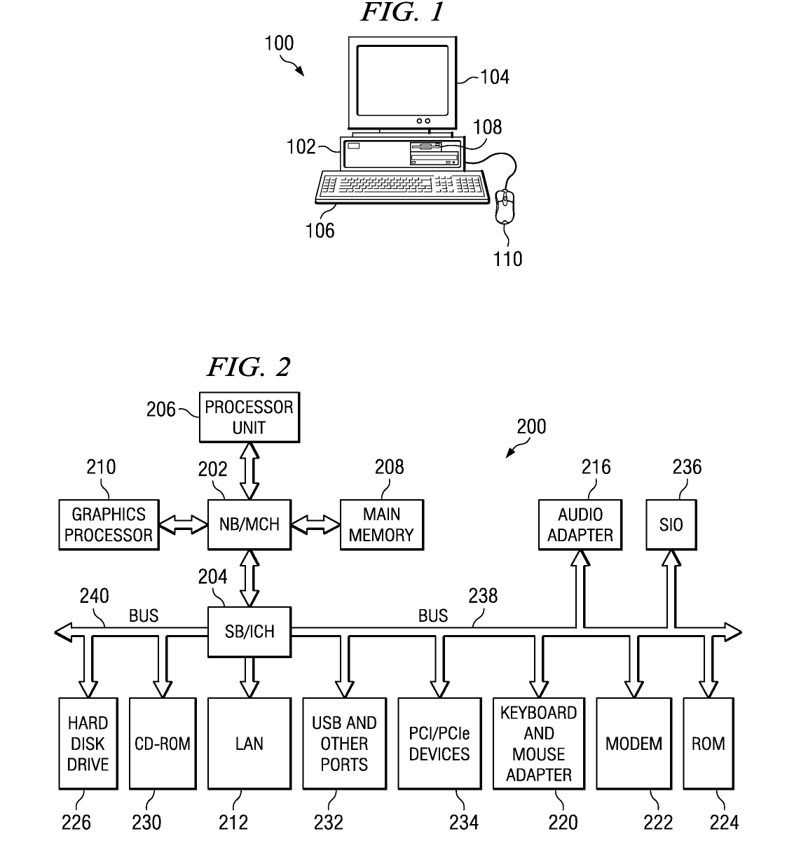

Next, FIG. 2 depicts a block diagram of a data processing system in which illustrative embodiments may be implemented. Data processing system 200 is an example of a computer, such as computer 100 in FIG. 1, in which code or instructions implementing the processes of the illustrative embodiments may be located.

In the depicted example, data processing system 200 employs a hub architecture including a north bridge and memory controller hub (MCH) 202 and a south bridge and input/output (I/O) controller hub (ICH) 204. Processing unit 206, main memory 208, and graphics processor 210 are coupled to north bridge and memory controller hub 202. Processing unit 206 may contain one or more processors and even may be implemented using one or more heterogeneous processor systems. Graphics processor 210 may be coupled to the MCH through an accelerated graphics port (AGP), for example.

In the depicted example, local area network (LAN) adapter 212 is coupled to south bridge and I/O controller hub 204, audio adapter 216, keyboard and mouse adapter 220, modem 222, read only memory (ROM) 224, universal serial bus (USB) ports, and other communications ports 232. PCI/PCIe devices 234 are coupled to south bridge and I/O controller hub 204 through bus 238. Hard disk drive (HDD) 226 and CD-ROM drive 230 are coupled to south bridge and I/O controller hub 204 through bus 240.

PCI/PCIe devices may include, for example, Ethernet adapters, add-in cards, and PC cards for notebook computers. PCI uses a card bus controller, while PCIe does not. ROM 224 may be, for example, a flash binary input/output system (BIOS). Hard disk drive 226 and CD-ROM drive 230 may use, for example, an integrated drive electronics (IDE) or serial advanced technology attachment (SATA) interface. A super I/O (SIO) device 236 may be coupled to south bridge and I/O controller hub 204.

An operating system runs on processing unit 206. This operating system coordinates and controls various components within data processing system 200 in FIG. 2. The operating system may be a commercially available operating system, such as Microsoft® Windows XP®. (Microsoft® and Windows XP® are trademarks of Microsoft Corporation in the United States, other countries, or both). An object oriented programming system, such as the Java™ programming system, may run in conjunction with the operating system and provides calls to the operating system from Java™ programs or applications executing on data processing system 200. Java™ and all Java-based trademarks are trademarks of Sun Microsystems, Inc. in the United States, other countries, or both.

Instructions for the operating system, the object-oriented programming system, and applications or programs are located on storage devices, such as hard disk drive 226. These instructions and may be loaded into main memory 208 for execution by processing unit 206. The processes of the illustrative embodiments may be performed by processing unit 206 using computer implemented instructions, which may be located in a memory. An example of a memory is main memory 208, read only memory 224, or in one or more peripheral devices.

The hardware shown in FIG. 1 and FIG. 2 may vary depending on the implementation of the illustrated embodiments. Other internal hardware or peripheral devices, such as flash memory, equivalent non-volatile memory, or optical disk drives and the like, may be used in addition to or in place of the hardware depicted in FIG. 1 and FIG. 2. Additionally, the processes of the illustrative embodiments may be applied to a multiprocessor data processing system.

The systems and components shown in FIG. 2 can be varied from the illustrative examples shown. In some illustrative examples, data processing system 200 may be a personal digital assistant (PDA). A personal digital assistant generally is configured with flash memory to provide a non-volatile memory for storing operating system files and/or user-generated data. Additionally, data processing system 200 can be a tablet computer, laptop computer, or telephone device.

Other components shown in FIG. 2 can be varied from the illustrative examples shown. For example, a bus system may be comprised of one or more buses, such as a system bus, an I/O bus, and a PCI bus. Of course the bus system may be implemented using any suitable type of communications fabric or architecture that provides for a transfer of data between different components or devices attached to the fabric or architecture. Additionally, a communications unit may include one or more devices used to transmit and receive data, such as a modem or a network adapter. Further, a memory may be, for example, main memory 208 or a cache such as found in north bridge and memory controller hub 202. Also, a processing unit may include one or more processors or CPUs.

The depicted examples in FIG. 1 and FIG. 2 are not meant to imply architectural limitations. In addition, the illustrative embodiments provide for a computer implemented method, apparatus, and computer usable program code for compiling source code and for executing code. The methods described with respect to the depicted embodiments may be performed in a data processing system, such as data processing system 100 shown in FIG. 1 or data processing system 200 shown in FIG. 2.

The different embodiments recognize that one aspect of performance problems with applications are related to cache misses that are caused by L2 cache intervention or simple cache misses. This problem is compounded by garbage collection in virtual machines, such as a Java™ Virtual machine, which may move objects that are placed in a heap. The different embodiments recognize that currently available performance or profiling tools are unable to associate data accesses in a heap with actual objects or with a call stack of functions that identify the context or reason why the objects are being accessed. The different embodiments recognize that identifying these objects may help understand problems associated with cache misses. The different embodiments recognize that producing reports to identify specific objects in a call stack context would increase the ability to analyze problems related with object accesses.

The illustrative embodiments provide a computer implemented method, apparatus, and computer usable program code for profiling objects. A set of data addresses are identified for a set of objects in response to an event involving the set of objects. This event may be an interrupt or some other signal indicating that a cache miss has occurred. Most processors provide support for performance monitor counting and taking performance monitor interrupts for different events. Some processors may allow for counting events, such as a load or store that exceed some threshold of execution time or that have specific type of cache misses, such as a L2 intervention. Any events that identify variations of cache misses may be used to profile access to objects on a heap. A determination is made as to whether any of the addresses correspond to a set of objects located in a heap for a virtual machine. If an address corresponds to an object in the set of objects present in the heap, call stack information for a thread causing the event is obtained. In these examples, only one call stack is obtained from the Java virtual machine for each sample. Separate objects may be inserted as separate leaf nodes in the obtained call stack.

This call stack information is obtained for each sample object in these examples. The set of objects may be a single object with the set of addresses being a single address in which the address is identified from an instruction pointer that is returned with the event. The instruction pointer points to an instruction that was being executed when the event occurred. From this instruction, a data address may be decoded. This decoding may require accessing the saved registers in the application space.

In other embodiments, the data address may be included in the hardware performance monitoring support. In many PowerPC processors, the Sampled Instruction Address Register (SIAR) and Sampled Data Address Register (SDAR) are captured by the hardware at the time the interrupt is signaled. PowerPC processors are available from International Business Machines Corporation. In some cases, identification of cache lines from an address may be known. As a result, a set of addresses from the cache line may be used to determine whether objects in the cache line are present in the heap.

In the depicted embodiments, a sampling of an object or data hot spot is performed instead of code hotspots as currently provided. A data hot spot is an area of data that is accessed more than some selected threshold value. The different embodiments provide a mechanism to identify objects relating to these hot spots in a heap with minimal effect on the performance of the system.

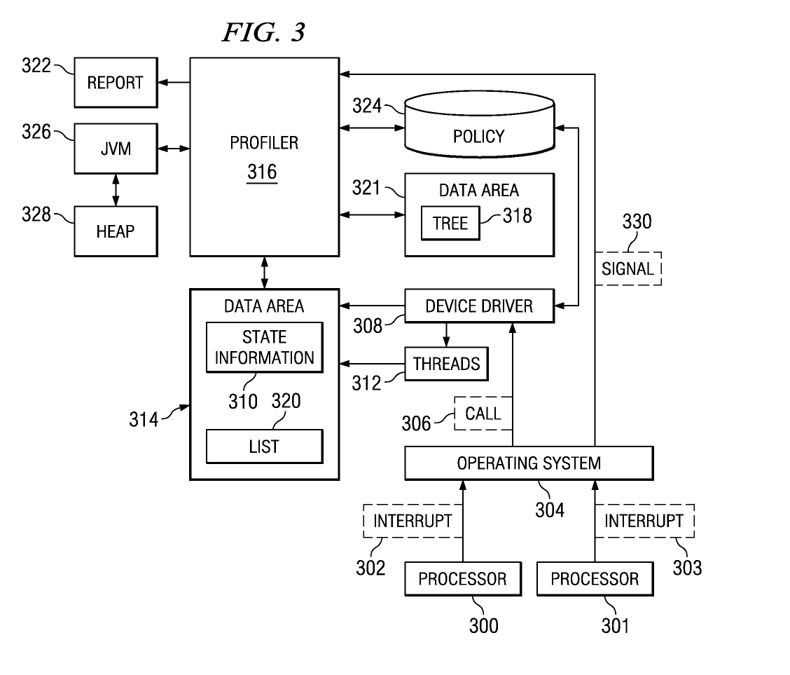

Turning now to FIG. 3, a diagram illustrating components used in profiling heap objects is depicted in accordance with an illustrative embodiment. In this depicted example, the components are examples of hardware and software components found in a data processing system, such as data processing system 200 in FIG. 2.

Processor 300 may generate interrupt 302, which may result in call 306 being made by operating system 304. Processor 301 may generate interrupt 303, which may result in call 306. Call 306 is identified and processed by device driver 308. In an alternative embodiment, the device driver may get direct control at the time the interrupt is generated.

Device driver 308 receives call 306 through hooks, in these examples, or directly by receiving control from the hardware interrupt processing support. A hook is a break point or callout that is used to call or transfer control to a routine or function for additional processing, such as queuing a Deferred Procedure Call (DPC), which would signal a sampling thread or signaling a sampling thread directly.

For example, when device driver 308 receives call 306 and determines that a sample should be taken, device driver 308 sends signal 330 to a sampling thread for profiler 316 to collect call stack information for the thread that was interrupted through list 320, which contains the information for the interrupted thread in threads 312. List 320 may contain interrupted thread information for each processor.

In a preferred embodiment, tree 318 is created within in a data area separate from data area 314, such as data area 321. Tree 318 contains call stack information and may also include leaf nodes identifying objects on the heap.

Profiler 316 is an application that is sample based. Profiler 316 gets control and determines if the data address is an address on the heap and if so gets a call stack from the Java™ virtual machine.

Illustrative embodiments are applied to multi-processor systems in which two or more processors are present. In these types of systems, each processor may take an interrupt and identify a candidate thread for obtaining a call stack.

In these examples, when an interrupt, such as interrupt 302 or interrupt 303 occurs, device driver 308 may check policy 324 and then may generate signal 330. This signal is sent to profiler 316 to initiate sampling of call stack information. The policy may validate that a previous sample has been processed or enough time has elapsed since the last sample. In these examples, the signal typically includes information, such as, for example, an instruction pointer, a data address pointer, a process identifier, and a thread identifier. This information may be provided through state information 310 in data area 314 in these examples. The instruction pointer points to an instruction being executed when the interrupt is generated. In some cases, a data address may be included in the data area or in signal 330. If a data address is not present in signal 330, profiler 316 may identify the address by decoding the instruction identified by the instruction pointer.

With an identification of the data address, profiler 316 may send a request or call to Java™ virtual machine (JVM) 326 to determine whether the address corresponds to an object in heap 328. Heap 328 is a data area in which objects are stored for Java™ virtual machine 326 in these examples. Java™ virtual machine 326 includes a process to receive the request from profiler 316 and determine whether the data address corresponds to an object in heap 328. If the address corresponds to an object within heap 328, this result is returned to profiler 316 by Java™ virtual machine (JVM) 326. The Java™ virtual machine may determine whether an address is an address of an object within heap 328 using a bit map that identifies the beginning of objects in heap 328. A bit in the bit map corresponds to the smallest size of an object in heap 328.

In turn, profiler 316 may then call Java™ virtual machine 326 to obtain call stack information for a thread associated with the instruction being executed when the interrupt occurred. For example, profiler 316 may request the call stack information when a cache miss occurs if the cache miss corresponds to an object or objects in heap 328.

Additionally, profiler 316 may be able to identify the cache line where the cache miss occurred and request a list of objects from Java virtual machine 326 that are in heap 328 using addresses for the cache line.

This information is obtained and then stored in data area 314 in these examples. This information may be used to generate tree 318 for the code executing at the time the cache miss occurs. Tree 318 also may include an identification of accessed objects. Additionally, in these illustrative examples, Java™ virtual machine 326 may tag objects in heap 328 based on identifying them from addresses by profiler 316 or in response to a request for the objects to be tagged. Objects may be tagged in a number of different ways. For example, each object may have a unique 64 bit identifier. Tags may be used to keep track of objects in the heap that have been moved to another place in the heap due to garbage collection, in order to avoid duplicating a node for an object that has been moved.

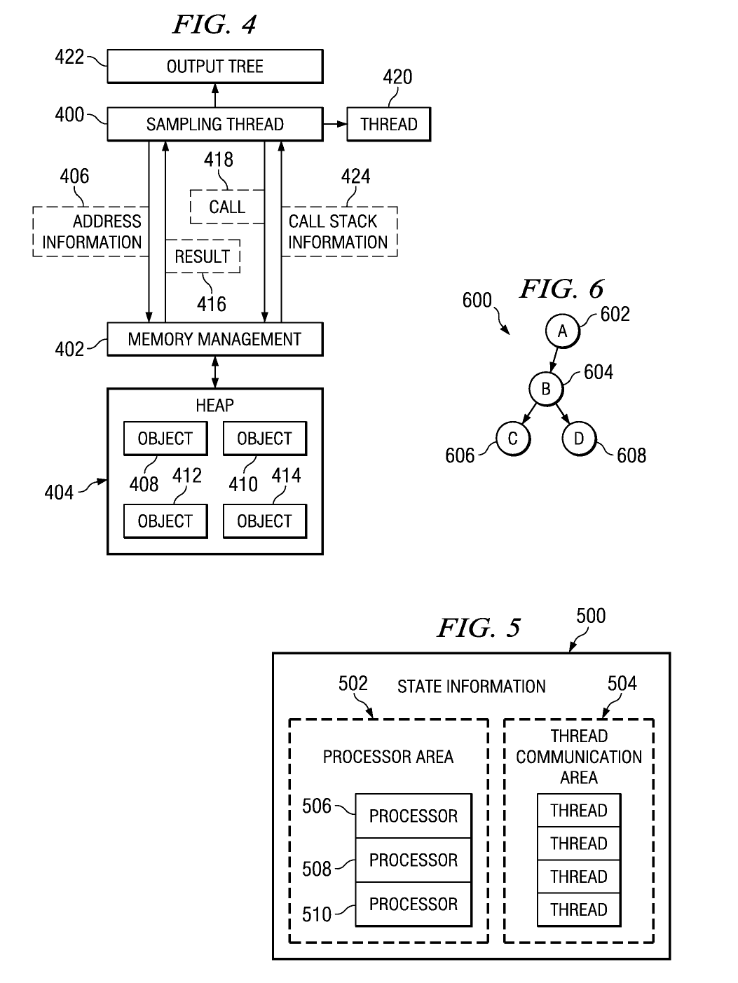

Turning now to FIG. 4, a diagram illustrating components used in determining whether objects are present in a heap and to obtain call stack information is depicted in accordance with an illustrative embodiment. In this example, memory management 402 is a component located in a Java virtual machine, such as Java virtual machine 326 in FIG. 3. Sampling thread 400 is a thread that is initiated by a profiler, such as profiler 316 in FIG. 3. In these examples, sampling thread 400 receives a signal from a device driver, such as device driver 308 in FIG. 3 that causes sampling thread 400 to be dispatched and execute. Signal 330 in FIG. 3 is an example of the signal received by sampling thread 400.

Heap 404 is an example of heap 328 in FIG. 3. In this example, sampling thread 400 sends address information 406 to memory management 402. Address information 406 is a set of one or more addresses. Memory management 402 includes processes to determine whether the addresses within address information 406 correspond to objects in heap 404.

In this example, heap 404 contains objects 408, 410, 412, and 414. If address information 406 corresponds to one or more objects in heap 404, the identification of the object is returned in result 416 to sampling thread 400. An object, called jobject, may be returned by the Java™ Virtual Machine Tool Interface (JVMTI) in these examples. If one or more objects are returned in result 416, sampling thread 400 obtains call stack information for one or more threads. In these examples, sampling thread 400 sends call 418 to the Java™ virtual machine. In particular, this call may be sent to memory management 402. In response to receiving call 418, memory management 402 retrieves call stack information 424 and returns this information to sampling thread 400, which generates output tree 422 from call stack information 424.

For example, if address information 406 corresponds to object 408 and 410 in heap 404, sampling thread 400 sends call 418 to memory management 402 to obtain call stack information for threads associated with the instruction being executed. In this depicted example, sampling thread 400 may sample or obtain call stack information for thread 420. This information may be placed into output tree 422, which is similar to tree 318 in FIG. 3. Output tree 422 may be accessed by a profiler, such as profiler 316 in FIG. 3, to analyze the objects. Further, the object or objects may be added as leaf node(s) in output tree 422, and information about the object or objects at the time the sample is taken may be included as base metrics for these leaf node(s) for the call stack.

Turning to FIG. 5, a diagram illustrating state information is depicted in accordance with an illustrative embodiment. In this example, state information 500 is an example of state information 310 in FIG. 3. State information 500 contains processor area 502 and thread communication area 504.

In this example, processor area 502 contains interrupted thread ID 506, instruction address 508, and data address 510 for which call stack information may be obtained.

The sampling thread looks in a shared data area, such as data area 314 in FIG. 3 to identify the thread that should be sampled.

A call tree is constructed by getting the call stack from the Java™ virtual machine at the time of a sample. The call tree may be constructed by monitoring method/function entries and exits. In these examples, however, call tree 600 in FIG. 6 is generated using samples obtained by a sampling thread, such as sampling thread 400 in FIG. 4. This call tree can be stored as tree 318 in FIG. 3 or as a separate file that can be merged in by profiler 316 in FIG. 3

Turning to FIG. 6, a diagram of a call tree is depicted in accordance with an illustrative embodiment. Tree 600 is an example of a call tree, such as tree 318 in FIG. 3. Tree 600 is accessed and modified by an application, such as profiler 316 in FIG. 3. In this example, tree 600 contains nodes 602, 604, 606, and 608. Node 602 represents an entry into method A, node 604 represents an entry into method B, and nodes 606 and 608 represent entries into method C and D respectively. A leaf node is the last node in a branch of tree of nodes. In these illustrative examples, nodes 606 and 608 are leaf nodes in which information about one or more objects being accessed at the time the sample is taken may be included.

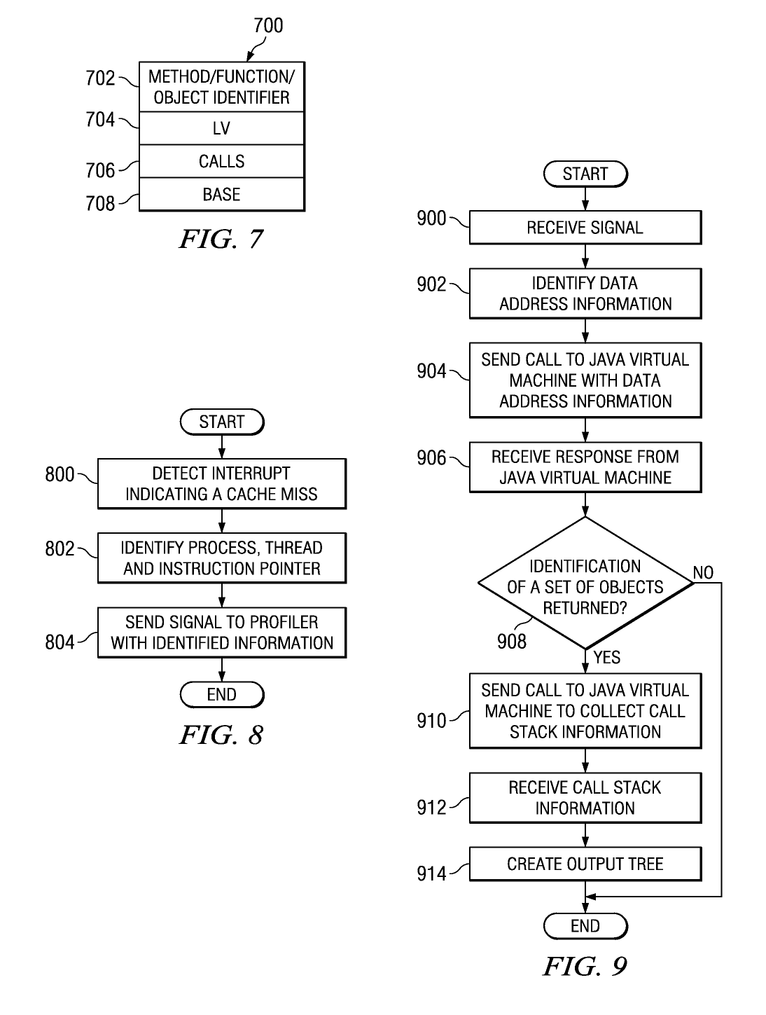

Turning now to FIG. 7, a diagram illustrating information in a node is depicted in accordance with an illustrative embodiment. Entry 700 is an example of information in a node, such as node 602 in FIG. 6. In this example, entry 700 contains method/function/object identifier 702, tree level (LV) 704, number of calls (CALLS) 706, and base 708, where base 708 may indicate number of samples, or other information about the objects.

The information within entry 700 is information that may be generated for a node within a tree. For example, method/function/object identifier 702 contains the name of the method or function. This entry also contains an identification of one or more objects on the heap. Tree level (LV) 704 identifies the tree level of the particular node within the tree. For example, with reference back to FIG. 6, if entry 700 is for node 602 in FIG. 6, tree level 704 would indicate that this node is a root node.

Other types of information may be included within entry 700 depending on the particular implementation. The particular fields are presented for purposes of providing examples of information that may be included in a node.

Turning now to FIG. 8, a flowchart of a process for signaling a cache miss in a profiler is depicted in accordance with an illustrative embodiment. The process illustrated in FIG. 8 may be implemented in an operating system, such as operating system 304 in FIG. 3.

The process begins by detecting an interrupt indicating a cache miss has occurred (step 800). The process, thread, and instruction pointer are identified (step 802). A signal is sent to the profiler with the identified information (step 804). The process terminates thereafter.

With reference now to FIG. 9, a flowchart of a process for identifying and profiling a heap object is depicted in accordance with an illustrative embodiment. The process illustrated in FIG. 9 may be implemented in a profiler, such as profiler 316 in FIG. 3. More specifically, the process illustrated in FIG. 9 may be implemented in a sampling thread initiated by the profiler. Sampling thread 400 in FIG. 4 is an example of a sampling thread in which these processes may be implemented.

The process begins by receiving a signal (step 900). Data address information is identified (step 902). A call is sent to a Java™ virtual machine with the data address information (step 904). A response is received from the Java™ virtual machine (step 906). A determination is made as to whether an identification of a set of objects is returned from the Java™ virtual machine (step 908). If an identification of a set of objects is returned, a call is sent to a Java™ virtual machine to collect call stack information (step 910). The call stack information is for a set of one ore more threads that are identified using a list and/or a policy. In response to a call, call stack information is received from the Java™ virtual machine (step 912).

Thereafter, the process creates an output tree from the received call stack information (step 914) with the process terminating thereafter. If identification of a set of objects is not returned in step 908, the process also terminates.

Thus, the different illustrative embodiments provide a computer implemented method, apparatus, and computer usable program code for profiling objects. A set of data addresses for a set of objects is identified in response to an event involving the set of objects. A determination is made as to whether any of the objects within the set of objects is located in a heap for a virtual machine using the data addresses. In response to an object in the set of objects present in the heap, call stack information is obtained for a thread causing event. This call stack information is obtained for each object in the set of objects that has been identified as being present in the heap. In this manner, the different embodiments allow for information on objects to be obtained to allow for profiling of the objects when different events occur.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for profiling objects, the computer implemented method comprising:
responsive to detecting an event involving a set of objects, identifying a set of data addresses for the set of objects;
determining whether any of the set of objects are located in a heap for a virtual machine using the set of data addresses; and
responsive to an object in the set of objects being located in the heap, obtaining call stack information for a thread causing the event, wherein the call stack information associated with the event is obtained for use in profiling the object.

2. The computer implemented method of claim 1, wherein the set of data addresses is a single data address, wherein the set of objects is a single object, and wherein the identifying step comprises:
responsive to detecting the event, identifying an instruction pointer from a signal associated with the event;
identifying an instruction pointed to by the instruction pointer to form an identified instruction, wherein the identified instruction caused the event; and
decoding the single data address for the single object from the identified instruction.

3. The computer implemented method of claim 1, wherein the identifying step comprises:
identifying the set of data addresses from a signal received from an operating system.

4. The computer implemented method of claim 1, wherein the event is an interrupt.

5. The computer implemented method of claim 4, wherein the interrupt is generated in response to a cache miss.

6. The computer implemented method of claim 5, wherein the set of data addresses are addresses for a cache line.

7. The computer implemented method of claim 1 further comprising:
creating an output tree using the call stack information obtained from the virtual machine and placing each object in the set of objects present in the heap in the output tree.

8. The computer implemented method of claim 1, wherein the obtaining step comprises:
activating a sampling thread to collect the call stack information.

9. The computer implemented method of claim 1, wherein the determining step comprises:
sending the set of data addresses to the virtual machine; and
receiving a response from the virtual machine identifying any objects present in the heap that correspond to the set of data addresses.

10. The computer implemented method of claim 1, wherein the identifying, determining, and obtaining steps are performed by a profiler.

11. The computer implemented method of claim 1, wherein the call stack information for the event is call stack information for each object present in the heap.

12. A computer program product comprising:
a computer usable medium having computer usable program code for profiling objects, the computer program medium comprising:
computer usable program code, responsive to detecting an event involving a set of objects, for identifying a set of data addresses for the set of objects;
computer usable program code for determining whether any of the set of objects are located in a heap for a virtual machine using the set of data addresses; and
computer usable program code, responsive to an object in the set of objects being located in the heap, for obtaining call stack information for a thread causing the event, wherein the call stack information associated with the event is obtained for use in profiling the object

13. The computer program product of claim 12, wherein the set of data addresses is a single data address, wherein the set of objects is a single object, and wherein the computer usable program code, responsive to detecting an event involving a set of objects, for identifying a set of data addresses for the set of objects comprises:
computer usable program code, responsive to detecting the event, for identifying an instruction pointer from a signal associated with the event;
computer usable program code for identifying an instruction pointed to by the instruction pointer to form an identified instruction, wherein the identified instruction caused the event; and
computer usable program code for decoding the single data address for the single object from the identified instruction.

14. The computer program product of claim 12, wherein the computer usable program code, responsive to detecting an event involving a set of objects, for identifying a set of data addresses for the set of objects comprises:
computer usable program code for identifying the set of data addresses from a signal received from an operating system.

15. The computer program product of claim 12, wherein the event is an interrupt.

16. The computer program product of claim 15, wherein the interrupt is generated in response to a cache miss.

17. The computer program product of claim 16, wherein the set of data addresses are addresses for a cache line.

18. The computer program product of claim 12 further comprising:
computer usable program code for creating an output tree using the call stack information obtained from the virtual machine and placing each object in the set of objects present in the heap in the output tree.

19. The computer program product of claim 12, wherein the computer usable program code, responsive to an object in the set of objects being located in the heap, for obtaining call stack information for a thread causing the event, wherein the call stack information is obtained for each object in the set of objects present in the heap comprises:
computer usable program code for activating a sampling thread to collect the call stack information.

20. A data processing system comprising:
a bus;
a communications unit connected to the bus;
a storage device connected to the bus, wherein the storage device includes computer usable program code; and
a processor unit connected to the bus, wherein the processor unit executes the computer usable program code to identify a set of data addresses for a set of objects in response to detecting an event involving the set of objects; determine whether any of the set of objects are located in a heap for a virtual machine using the set of data addresses; and obtain call stack information for a thread causing the event, in response to an object in the set of objects being located in the heap, wherein the call stack information associated with the event is obtained for use in profiling the object.
